(19) United States
(12) Patent Application Publication
(10) Pub. No.: US 2023/0260498 A1
(43) Pub. Date: Aug. 17, 2023

(54) ACOUSTIC SUPPRESSION SYSTEM

(71) Applicant: Taurus Technologies Holdings, Inc., Barrington, IL (US)

(72) Inventors: Marta MAGNUSSON, Grimsby (CA); Stefan MAGNUSSON, Grimsby (CA)

(73) Assignee: Taurus Technologies Holdings, Inc., Barrington, IL (US)

(21) Appl. No.: 18/109,010

(22) Filed: Feb. 13, 2023

Related U.S. Application Data
(60) Provisional application No. 63/309,645, filed on Feb. 13, 2022.

(51) Int. Cl. G10K 11/178; F02K 1/34; F04D 29/66

(52) U.S. Cl. CPC G10K 11/17823; G10K 11/17873; B64D 33/06; F04D 29/663; G10K 2210/3044; G10K 2210/3027; G10K 2210/3046; G10K 2210/1281

(57) ABSTRACT

A fan blade assembly having integrated microphones to measure acoustic energy levels uses speakers controlled by a control unit to output anti-acoustic energy vibrations. Specific embodiments wherein the speakers and microphones are radially displaced around the fan blade assembly are also disclosed.

### CLAIM OF PRIORITY FROM PROVISIONAL PATENT APPLICATION

This application claims priority from U.S. Provisional Patent Application 63/309,645, “ACOUSTIC SUPPRESSION SYSTEM,” filed Feb. 13, 2022 in the United States Patent and Trademark Office, said application by the same inventive entity, with the entirety of said application being incorporated herein by reference to provide continuity of disclosure.

This invention relates to an acoustic suppression system which allows dynamic acoustic suppression of sound waves generated by a rotating propeller. The suppression reduces noise levels and allows for dynamic correction of imbalances or undesired vibrations in the spinning propeller.

### BACKGROUND OF THE INVENTION

The present invention relates to acoustic suppression in a fan blade assembly. Fan blade assemblies, such as those used in drone aircraft, are well known in the art. A motor is used to rotate a fan blade which pushes air in a single direction, creating lift or thrust. Such assemblies can also be used to move heated air away from something which is to be cooled or toward something which is to be heated.

Fan blade assemblies often spin extremely fast under significant loads, e.g. the propeller in a Vertical Takeoff and Landing aircraft (“VTOL” or “eVTOL” if the propeller is driven by an electric motor) may spin at many thousands of revolutions per minute (RPM) and pushing out hundreds of pounds of lifting force. This requires a great deal of energy, some of which may, through inefficiency or unavoidable engineering tradeoffs, manifest as undesired vibrations. These vibrations can make the motor less efficient and increase wear and tear on the components. Also, these vibrations can in turn produce undesired levels of sound, making the motor louder than it would be otherwise.

A system for reducing undesired vibrations in fan blade assemblies would therefore be a useful invention.

Further, a system for reducing undesired levels of sound in fan blade assemblies would therefore be a useful invention.

The present invention addresses these concerns.

### SUMMARY OF THE INVENTION

Among the many objectives of the present invention is the provision of an acoustic suppression system which dynamically detects and counters undesired vibration in a fan blade assembly.

Another objective of the present invention is the provision of an acoustic suppression system which dynamically reduces noise levels in a fan blade assembly.

Other objectives and advantages of the present invention will become apparent to those of ordinary skill in the art upon review of the disclosure hereof.

### BRIEF DESCRIPTION OF THE DRAWINGS

FIG. 1 depicts a perspective view of a first embodiment of the acoustic suppression system integrated into a fan blade assembly.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

Though useful for many applications, the invention will be described as a fan blade assembly intended for use in an aeronautical application such as to provide lift and/or thrust to an aircraft capable of VTOL especially but not limited to eVTOL aircraft. It will be apparent to persons of ordinary skill in the art that the fan blade assembly can also be used in conventional aircraft or in any other suitable application that requires air to be moved in a controlled direction.

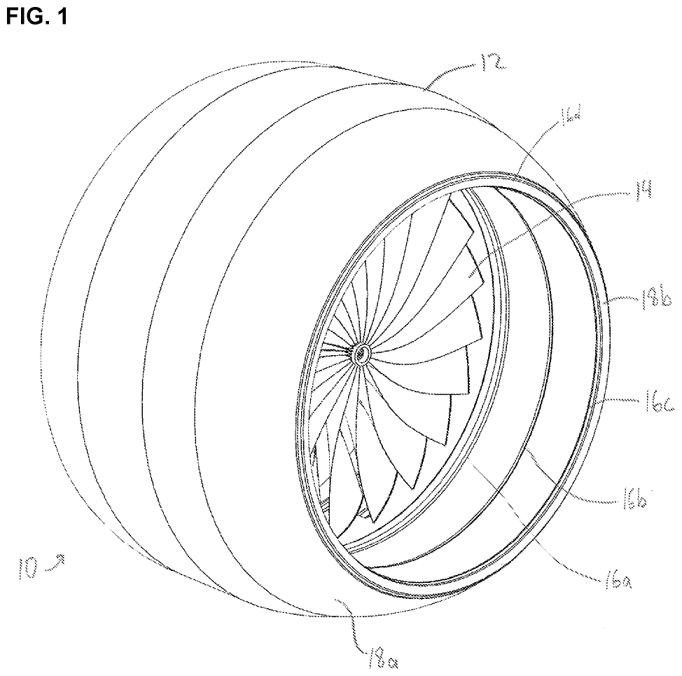

By referring to FIG. 1, the acoustic suppression system can be easily understood. Fan blade assembly 10, here styled as a ducted fan assembly for an eVTOL aircraft, has housing 12 which surrounds fan blade 14. Fan blade 14 rotates and pushes air to provide lift and/or thrust for the eVTOL aircraft. Integrated into housing 12 are microphones 16a, 16b, 16c, and 16d. Also integrated into housing 12 are speakers 18a and 18b.

During operation, fan blade 14 rotates, driven by a motor (NOT SHOWN.) Air is pushed through a duct formed by housing 12, directed to create lift and or thrust as desired. By rotating the fan blade assembly on an axis perpendicular to the rotational plane of fan blade 14, the moving air will push against the fan blade assembly, and thus the eVTOL aircraft, with the push becoming lift and/or thrust depending on the orientation of the fan blade assembly.

Vibrations caused by the rotation of fan blade 14 and/or the movement of air through housing 12 can produce wear and tear on the fan blade assembly. They can also produce excessive levels of audible acoustic energy (sound.) Microphones 16 detect these vibrations, which may or may not be in the portion of the sound spectrum audible to a typical human being, and measure where on the circumference of housing 12 they are most intense as well as their overall intensity. Microphones 16 transmit these measurements to a control unit (not shown.) The control unit may be a general purpose computer, a special purpose computer, a specialized integrated circuit, or any other reasonable means of performing mathematical operations on the measurements produced by microphones 16, and then in turn controlling speakers 18.

The control unit then uses the speakers to create anti-acoustic energy vibrations, as indicated by its programming or circuitry configuration. For example, if a harmonic oscillation is detected, the speakers could be used to generate anti-acoustic energy vibrations which will disrupt the harmonic oscillation and prevent it from building up and damaging the fan blade assembly.

For another example, if the microphones detect a level of noise in excess of a predetermined static or dynamic limit, the control unit can use the speakers to perform active noise cancellation, a process well known in the acoustic sciences which, in summary, generates an inverse sound wave which cancels out the noise at one or more fixed areas.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed is:

1. A fan blade assembly comprising:
a) a fan blade, the fan blade operably connected to a motor, the motor causing the fan blade to rotate at a rotation speed;
b) a fan housing, the fan housing radially surrounding the fan blade in whole or in part;
c) at least one microphone which can detect a level of acoustic energy generated by the fan blade when the fan blade is rotated by the motor;
d) at least one speaker, the at least one speaker able to output an anti-acoustic energy vibration; and,
e) a control unit, the control unit operably connected to the at least one microphone and the at least one speaker such that the control unit can cause the at least one speaker to output the anti-acoustic energy vibration based upon the level of acoustic energy detected by the microphone.

2. An acoustic suppression system as in claim 1, wherein the at least one speakers are radially placed around an output duct for the fan blade assembly.

3. An acoustic suppression system as in claim 1, wherein the at least one microphones are radially placed around an output duct for the fan blade assembly.

4. An acoustic suppression system as in claim 2, wherein the at least one microphones are radially placed around an output duct for the fan blade assembly.

5. An acoustic suppression system as in claim 1, wherein the control unit is operably connected to the motor and can adjust a dynamic rotation speed of the motor to increase the acoustic suppression.

6. An acoustic suppression system as in claim 2, wherein the control unit is operably connected to the motor and can adjust a dynamic rotation speed of the motor to increase the acoustic suppression.

7. An acoustic suppression system as in claim 3, wherein the control unit is operably connected to the motor and can adjust a dynamic rotation speed of the motor to increase the acoustic suppression.

8. An acoustic suppression system as in claim 4, wherein the control unit is operably connected to the motor and can adjust a dynamic rotation speed of the motor to increase the acoustic suppression.
